(19) United States
(12) Patent Application Publication
(10) Pub. No.: US 2015/0206106 A1
(43) Pub. Date: Jul. 23, 2015

(54) METHOD FOR CREATING, ISSUING AND REDEEMING PAYMENT ASSURED CONTRACTS BASED ON MATHEMEMATICALLY AND OBJECTIVELY VERIFIABLE CRITERIA

(71) Applicant: YARON EDAN YAGO, SAN FRANCISCO, CA (US)

(72) Inventor: YARON EDAN YAGO, SAN FRANCISCO, CA (US)

(21) Appl. No.: 14/596,103

(22) Filed: Jan. 13, 2015

Related U.S. Application Data
(60) Provisional application No. 61/926,804, filed on Jan. 13, 2014.

(51) Int. Cl. G06Q 20/06

(52) U.S. Cl. CPC G06Q 20/0658; G06Q 20/0655; G06Q 2220/00

(57) ABSTRACT

A business method and a system are disclosed comprising a software/computer/firmware module that creates contract/credit certificates with verifiable and objective terms based on a trade request between two or more parties. The module of the present invention also monitors crypto-digital instrument networks, including crypto-digital financial networks, to verify performance of the expected terms and notifies a credit issuing party as to the status (complete/not complete) of the relevant contract/credit certificate. The module, by use of encryption techniques or cryptography, ensures that the credit issued is only issued once while verifying credit-certificates. The disclosed business method and system allows for credit issuing bodies to provide payment guarantees that may be claimed only upon meeting objectively and/or mathematically verifiable terms on crypto-digital instrument networks. Lastly, the invention provides a business method for using crypto-digital instrument networks to issue digital credit certificates that cannot be double-spent.

### CONTINUATION-IN-PART APPLICATION

The present application is a Continuation-in-Part Application of U.S. Provisional Patent Application Ser. No. 61/926,804 filed by Inventor Yaron Edan Yago on Jan. 13, 2014 and titled METHODS FOR CREATING, ISSUING AND REDEEMING PAYMENT ASSURED CONTRACTS BASED ON MATHEMATICALLY AND OBJECTIVELY VERIFIABLE CRITERIA, wherein the present Application claims benefit of the priority date of the filing of said U.S. Provisional Patent Application Ser. No. 61/926,804 filed on Jan. 13, 2014. Furthermore, said U.S. Provisional Patent Application Ser. No. 61/926,804 filed on Jan. 13, 2014 is hereby incorporated within the present Application in its entirety for all purposes.

### FIELD OF THE INVENTION

The present invention relates to the enabling transaction of one or more digital or hard copy private ledger systems in view of confirmable recordations of one or more of a plurality or multiplicity of nodes of a public ledger, wherein the public ledger is accessible by means of an electronics communications network

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A major innovation in transaction and financial technology is the development of Crypto-Digital Financial Instruments (hereinafter referred to as “CDFI). These are currencies, assets, commodities, derivatives or debts, etc., which are secured and verifiable utilizing various encryption schemes, primarily public/private encryption. Many of these systems make use of recent software innovations, including decentralized, networked or public ledgers, open source protocols and automated contracts. Most famous of these asset protocols is “Bitcoin”, however many others exist. These developments have, on the one hand, created transaction types that traditional payment methods are not well suited for and on the other hand, have created an opportunity for innovation in the payment and transaction industry.

More particularly, there is a need for a monetary system that solves for providing a method of settlement as between buyers and sellers of CDFI. Specifically, reducing counter-party risk involved in performing CDFI transactions where, for example, one transaction type may be irreversible and the other is reversible. Also, providing for the transaction to be (near) instant and secure while simultaneously having the settlement to be delayed, thereby solving the problem of transactions using payment methods which by way of example only, operates at different time scales.

Furthermore, a method is needed which allows for these new types of credit-based payments to be tied to mathematically verifiable events, wherein said events are a form of completion criteria. This allows for automated and scalable settlement protocols, which require no arbitrary judgments. Lastly, there is a need for a method that describes automatically issued digital contracts that may be automatically enforced, resulting in reduced fraud and counter-party risk when dealing with all different types of CDFI.

### SUMMARY AND OBJECTS OF THE INVENTION

Towards these objects and other objects that are made obvious in light of the present disclosure, an invented method and invented system are provided comprising an invented software/computer/firmware module that creates and applies contract/credit certificates with verifiable and objective terms based on a trade request between two or more parties. The invented module of the of the method of the present invention (hereinafter, “the invented method”) may be further adapted to monitor crypto-digital instrument networks, to verify performance of the expected terms and/or notify a credit issuing party as to the status, e.g., a complete/not complete status, of a contract, credit certificate, or other electronic document.

It is further that within the present disclosure the range of meaning of the term crypto-digital instrument (hereinafter, “CDI”) may comprise one or more crypto-digital instruments (hereinafter, “CDFI” in the singular) or other crypto-digital electronic documents. It is further understood that the range of meaning of the term CDFI as meant within the present disclosure includes crypto-currency types such as BITCOIN.

The module, by use of encryption techniques or cryptography, ensures that the credit issued is only issued once while verifying credit-certificates. The disclosed business method and system allows for credit issuing bodies to provide payment guarantees that may be claimed only upon meeting objectively/mathematically verifiable terms on CDFI networks. Lastly, the invention provides a business method for using CDFI networks to issue digital credit certificates that cannot be double-spent.

In one optional aspect of the invented method, mismatches in transaction timing and/or reversibility of transactions of public ledgers and private ledgers are addressed.

In another optional aspect of the invented method, transactions of two or more private ledgers may be conditioned upon confirmation of one or more transaction as recorded on a public ledger.

In yet another optional aspect of the invented method, executions and documentation of assignment and/or change of ownership of one or more private ledgers maintaining a register of ownership of commodities, financial securities, physical goods, digital assets and/or other electronic documents, to include CDI's, may be conditioned upon confirmation of one or more transaction as recorded on a public ledger.

In a still other optional aspect of the invented method, the operation of a private ledger may be coordinated with the operation of a public ledger, e.g., a blockchain or the BITCOIN BLOCKCHAIN, such that the operator of the private ledger may legally reduce or avoid taxes and/or avoid or reduce other regulatory barriers, legally imposed burdens and/or liabilities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a process diagram of an overview of an aspect of the invented method;

FIG. 2 is a process diagram of an overview of an additional aspect of the invented method;

FIG. 3 is a flowchart of an exemplary implementation of the invented method;

FIG. 4 is a network diagram of an electronic communications network, comprising a private ledger, a first user, a second user, a public ledger, and a transaction system comprising modules, bi-directionally connected by means of the Internet;

FIG. 5 is a process chart of a preferred implementation of the invented method;

FIG. 6 is a flowchart of an aspect of the invented method whereby a certificate module receives certificate information and generates a certificate;

FIG. 7 is a flowchart of a further aspect of the invented method whereby a monitoring module monitors the status of a contract;

FIG. 8 is a flowchart of a yet further aspect of the invented method whereby a workflow/status module directs and facilitates contract execution;

FIG. 9 is a flowchart of an additional aspect of the invented method whereby a proof of payment module facilitates movement of information concerning a designated transaction;

FIG. 10 is a flowchart of a yet additional aspect of the invented method whereby a dash procedure is performed;

FIG. 11A is a flowchart of an aspect of the invented method whereby a first certificate is generated;

FIG. 11B is a block diagram of an exemplary first contract;

FIG. 11C is a block diagram of an exemplary first certificate that is applicable to a fiat currency transaction;

FIG. 11D is a block diagram of an exemplary second certificate that is applicable to a title transaction, wherein the referenced title may be instrument that documents an assignment of a financial security, a non-financial instrument, a CDI, title to a physical object and/or an ownership right over a measure of a commodity, a crypto-digital instrument, a fiat currency instrument, a digital asset, or real property;

FIG. 12 is a flowchart of an aspect of the invented method whereby a first user device executes a sale;

FIG. 13 is a flowchart of an aspect of the invented method whereby a second user device executes a transaction;

FIG. 14 is a network diagram of an electronic communications network comprising a transaction system comprising modules, a second private ledger with which a third and fourth user device may communicate, a first private ledger with which a first and second user device may communicate, and a public ledger;

FIG. 15 is a flowchart of an aspect of the invented method whereby and Epiphyte server takes part in a transaction

FIG. 16 is a flowchart of an additional aspect of the invented method whereby the first private ledger takes part in a transaction

FIG. 17 is a flowchart of a further aspect of the invented method whereby the second private ledger takes part in a transaction

FIG. 18 is a flowchart of an aspect of the invented method whereby a first user device takes part in a transaction;

FIG. 19 is a flowchart of a further aspect of the invented method whereby a second user device takes part in a transaction;

FIG. 20 is a flowchart of a yet further aspect of the invented method whereby a third user device takes part in a transaction;

FIG. 21 is a flowchart of an aspect of the invented method whereby a fourth user device takes part in a transaction;

FIG. 22 is a block diagram of the CDI network of FIG. 4 comprising a plurality of nodes, each node preferably have an instance of either a BITCOIN BLOCHAIN and/or another suitable blockchain known in the art; and

FIG. 23 is a block diagram of a plurality of financial account records maintained in a financial database management system of the first private ledger and/or the second private ledger of FIG. 4.

### DETAILED DESCRIPTION

As a new method of business, a credit issuer could issue a credit certificate that is redeemable upon verified completion of certain terms. Typically, these terms require a seller to prove that they have performed the duties under an underlying contract (e.g., sale of goods contract). More specifically, the invention takes advantage of actions performed by using a CDI network (e.g., Bitcoin, Mastercoin, Ripple, etc.) By issuing such credit certificates, credit issuers could facilitate trade of CDIs in return for traditional assets and payments.

Currently, such trade is marked by inefficiency and risk wherein a buyer needs to either send a payment in advance of receiving CDI' S, including CDI's, or else convince a buyer to send CDIs before receiving payment, creating high counter party risk. CDI transfers are typically irreversible, whereas traditional payment forms are typically reversible, introducing additional risk for CDI sellers. Simple CDI transactions are instant but may take a great deal of time to verify with certainty adding additional time-related trading frictions.

Counter-parties to a trade often wish to maintain confidentiality in their trading activity. Maintaining privacy typically requires additional middle men and adds additional counter-party risk all of which is solved and/or eliminated in accordance with the present invention. Additionally, maintaining confidentiality on CDI networks typically requires use of various transaction-masking procedures which may add additional time to for each transaction. It is well known that time is a major barrier in these transactions as traders wish to agree on a price in volatile markets requiring rapid response on behalf of the trader. However, the time effects involved in waiting for the various payment methods may cause deals to be cancelled if market conditions move against one of the participants.

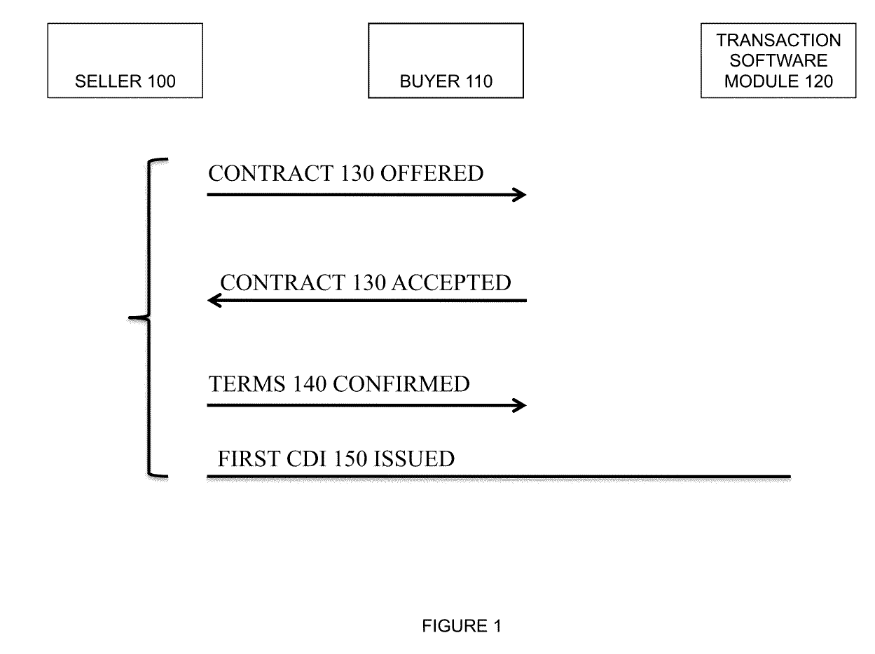

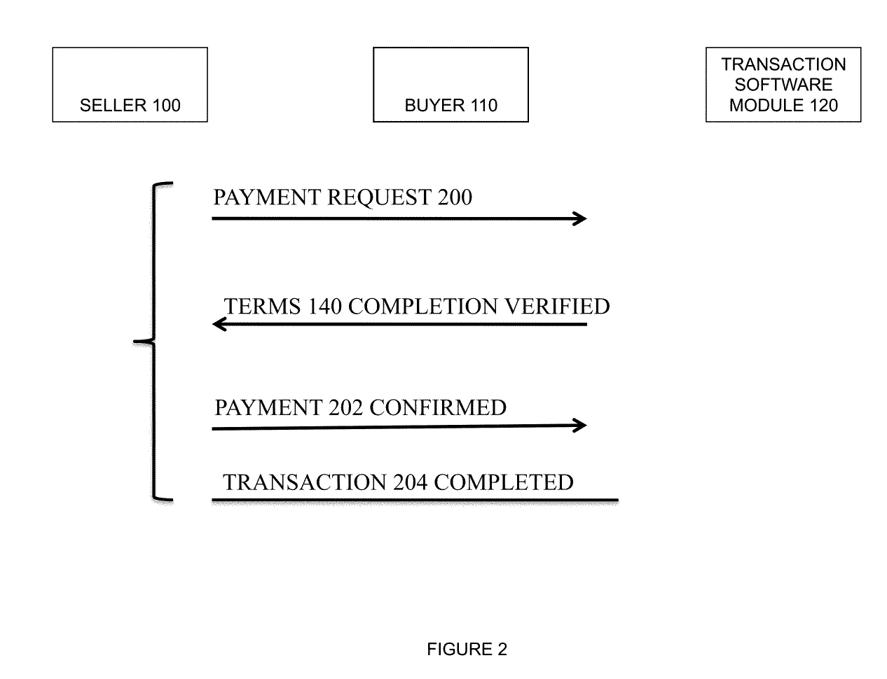

Referring now generally to the Figures, and particularly to FIG. 1 and FIG. 2, the invention disclosed herein is shown to utilize a method that separates the time of agreement and initial performance of a given trade, from the time of settlement, thereby allowing trading parties to overcome the above problems. At the same time, this method of trading allows parties to transact with the guarantee of settlement upon completion of all elements for that trade.

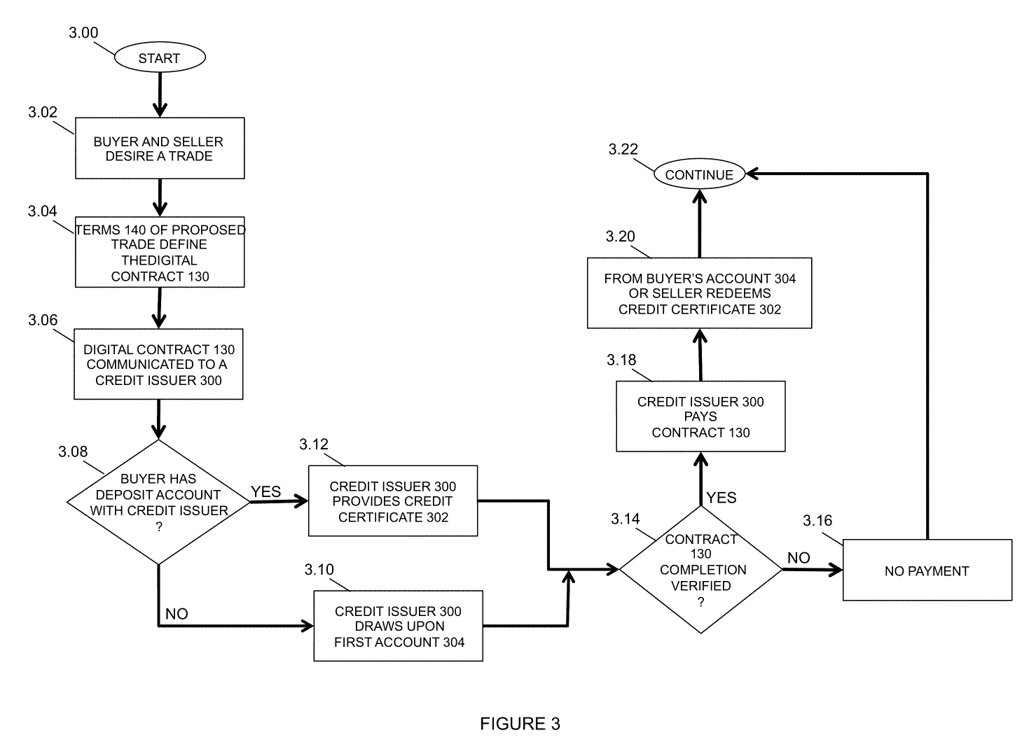

Referring now generally to the Figures, and particularly to FIG. 3, in one preferred embodiment, the service would operate as follows: buyers and sellers desire to perform a trade. The terms of their agreed trade define the criteria for a contract (which could be an automatically created digital contract). The contract is communicated to a credit issuer. The credit issuer draws upon securities deposited by the buyer, or in some other way provides the buyer with credit, against which a credit certificate would be issued. This credit certificate would be redeemable by the seller upon verified complete performance of the contracts terms.

A payment issuer will be able to objectively (and automatically), confirm performance by the seller, by either directly monitoring the CDI network or receiving a data feed from a trusted third-party. (All elements of the sale and completion of all obligations will be objectively verifiable, obviating the need for arbitrary assessment of the seller's performance or receipt of goods by the buyer.) The payment issuer honors the credit certificate providing payment to the holder. The trade is settled.

Credit certificates may be issued for any fractional amount of the total credit the credit issuers are willing to provide to the buyer. As credits are redeemed, the credit issuer subtracts the amount from the credit allowed to the buyer. Therefore, the buyer's credit changes dynamically, in real time, to changes in the credit amount allowed by the credit-issuer.

In another preferred embodiment, the system may take advantage of UCP 600 (the ICC Uniform Customs and Practice for Documentary Credits) or similar type of credit systems, treating the credit issued as a documentary credit. Thus the objective criteria, upon which payment is conditional, may be monitored. Proof of completion, as provided by this method, would be considered documentation sufficient for determining completion of contractual terms in accordance with UCP 600. In this way, no centralized authority is required for the documentation. Only objectively verifiable events on the public CDI ledgers are required. In such a way, the system could become a new form of letter-of-credit, issuable by financial bodies

In yet still another preferred embodiment, the method of the present invention is designed to allow the credit issuing body to also be the provider of the payment upon completion of the contract terms. Alternatively, payment may be provided by a different party, who would settle with the credit issuer or the buyer at a later date. Finally, the payment may be provided directly from the buyer, with the credit certificate acting as a guarantee for the seller. Lastly, software systems may be developed to support the described service. The first module of this software would create (digital) trade contracts that would include the verifiable terms upon which payment would be contingent after verification.

It is envisioned that this or a similar software module would create the credit-certificate based on the agreed upon trade or the trade contract. Such contracts and certificates could be developed to be automatically machine-readable, with standardized templates. A second software module would monitor CDI networks, e.g., a network having a plurality or multiplicity of nodes maintaining the BITCOIN BLOCKCHAIN, for the purpose of determining if contingent terms had been met. Examples of data that this module might monitor include required transaction amount, publicly time-stamped deadlines and cryptographically verifiable identities as well as more sophisticated data that will become available as such CDI systems evolve over time. Also, a third software module may be provided that would indicate to participants in the trade as to the status of when or how much of the terms in a contract are being fulfilled. This may be done as either an active “push” notification, or based on user-initiated query from the relevant party.

In still yet another preferred embodiment, a fourth software module may be provided that would allow for transmitting proof of payment for a given certificate. Proof of payment could be provided to any or all of the interested parties or to any third party. Proof of payment could be delivered over internal systems or on the public ledgers of CDI systems as either a message or a contract. Allowing for such proof of payment to be sent or broadcast would prevent credit certificate holders from “double spending” and would allow all parties to audit the transaction during performance of the terms. To allow for secure transmission, each payment party could cryptographically sign the transaction with a publicly knowable signature. Additionally, the payment could be withheld until counter-signed by the payment recipient. These signatures could be added to the credit certificate itself, in digital form, as well as to the digital contract.

It should be noted that both the contract and the certificate may be issued in three separate ways as follows: first, the contacts and certificates may be issued on a centralized, proprietary system, which the involved parties would have access to as users. An example of this would be an exchange, dark pool or clearinghouse, that the parties utilized to find trading partners on.

Secondly, the contracts and certificates may be issued on the public ledgers of the CDI systems, either as messages or as transactions, either digitally or in hard copy. To maintain the confidentiality using this method of issuance, these messages or transactions could be encrypted such that only authorized parties (the parties involved) would be able to decrypt and read the data. Third and lastly, a hybrid of these two systems may be utilized, where a pointer to the contract or certificate could be issued on the public ledgers. This could be publicly readable. However, the pointer message would direct users to a centrally held proprietary system, where only authorized users would have access to contract/certificate details.

Referring now generally to the Figures and particularly to FIG. 1, FIG. 1 is a process chart describing an outline of an aspect of the invented method involving interactions between a seller 100, a buyer 110, and a transaction software module 120. In the first interaction, an exemplary first digital contract 130 is offered by the seller 100 to the buyer 110, by means of the transaction software module 120. In the next interaction, the buyer 110 accepts the exemplary first contract 130 (hereinafter, “first contract 130”) from the seller 100. In the third interaction, one or more terms 140 of the exemplary first contract 130 are confirmed by means of bidirectional interaction between the seller 100 and the buyer 110. In the final interaction, a first CDI 150 is issued, according to the terms of the exemplary first contract 130.

Referring now generally to the Figures, and particularly to FIG. 2, FIG. 2 is a process chart describing an additional outline of an aspect of the invented method involving interactions between a seller 100, a buyer 110, and a transaction software module 120. In the first interaction, the seller 100 communicates a payment request 200 to the buyer 110 by means of the transaction software module 120. In the second interaction, a verification of completed terms 140 is communicated to the seller 100 from the buyer 110. In the third interaction, an exemplary payment 202 according to the completed terms 140 is confirmed between the seller 100 and the buyer 110. Finally, a first exemplary transaction 204 is completed.

Referring now generally to the Figures, and particularly to FIG. 3, FIG. 3 is a flowchart of an exemplary implementation of an aspect of the invented method whereby a desired transaction is executed between a buyer 110 and a seller 100. In step 3.02 the buyer 110 and the seller 100 communicate between themselves that an exemplary first trade is desired. In step 3.04 the buyer 110 and the seller 100 define in the digitized contract 130 the desired terms 140 of the proposed trade. In step 3.06 the terms 140 of the digital contract 130 are communicated to a credit issuer 300. In step 3.08 it is determined whether the buyer 110 has a credit account 302 with the designated credit issuer 300 to which the terms 140 of the digital contract 130 were communicated. When the determination in step 3.08 is negative, the credit issuer 300 draws upon the account of the buyer 110 for the amount of the proposed trade. Alternatively, when the determination in step 3.08 is positive, the credit issuer 300 provides a credit certificate 304 for the amount of the proposed trade. Upon execution of either step 3.10 or step 3.12, it is determined whether the completion of the contract 130 is verified. When the determination in step 3.14 is negative, no payment is issued in step 3.16. In the alternative, when the determination in step 3.14 is positive, the credit issuer 300 pays the contract 130 in step 3.18. In step 3.20 the credit issuer 300 chooses the source of the funds for payment of the contract 130. The process is subsequently terminated in step 3.22.

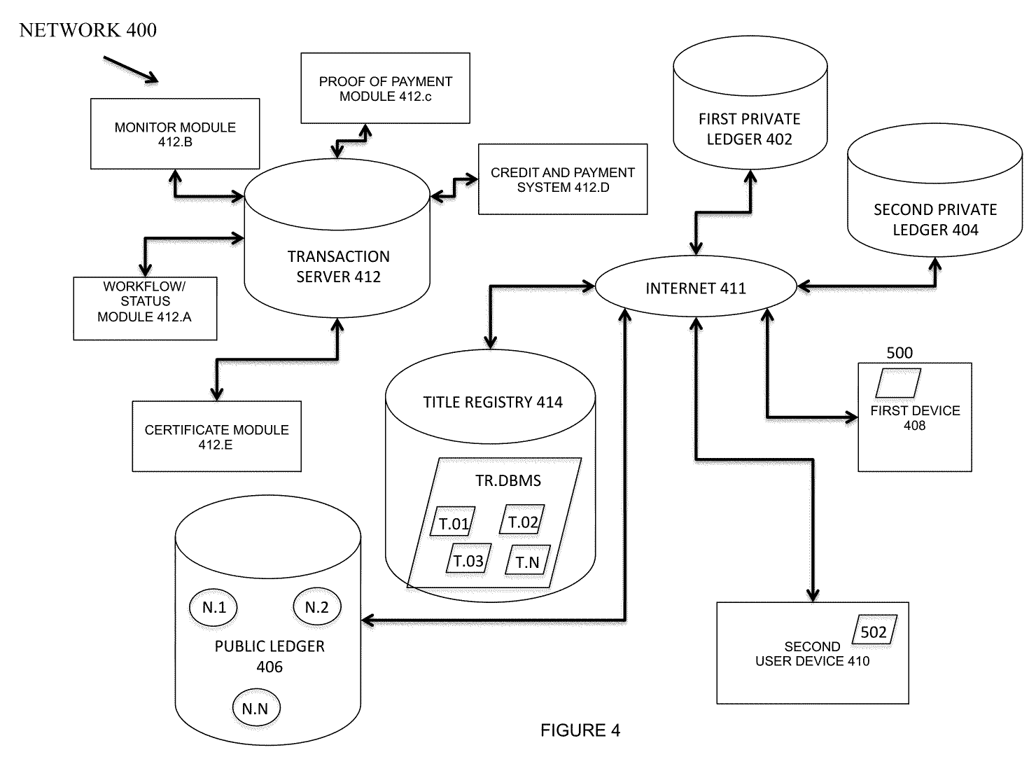

Referring now generally to the Figures, and particularly to FIG. 4, FIG. 4 is a network diagram of an electronic communications network 400 (hereinafter, “the network” 400), comprising a first private ledger 402, a second private ledger 404, a public ledger system 406, an exemplary first user device 408, an exemplary second user device 410, the Internet 411, a transaction system 412 comprising a plurality of modules 412.A-412.E, and a title registry server 414. The first private ledger 402 may be any type of private ledger known in the art, including, but not limited to a financial institution such as a bank, a credit union or a securities brokerage, a domain name registrar, and/or a holder of a portfolio of mortgages or other financial securities. The public ledger 406 is preferably a CFI network, and may be or comprise a plurality or multiplicity of nodes N.1-N.N. that each preferably maintain and dynamically update copies of a same public ledger, e.g., an accessible Blockchain BC.01-BC.N or the BITCOIN BLOCKCHAIN BTC.01-BTC.N.

The plurality of modules 412.A-412.E further comprises a workflow status module 412.A, a monitor module 412.B, a proof of payment module 412.C, a credit and payment system 412.D, and a certificate module 412.E.

A financial database management system FIN.DBMS of the (a.) first private ledger 402, (b.0 the second private ledger 404, (c.) the public ledger 406, (d.) the transaction system 412, and/or (e.) a title registry server 414, or a database management system of (a.) the first user device 408 (b.) the second user device 410,a and/or (c.) one or more nodes N.1-N.N of the public ledger 406 may be or comprise an object oriented database management system (“OODBMS”) and/or a relational database management system (“RDBMS”). More particularly, first private ledger 402, the second private ledger 404, the public ledger 406, the first user device 408, the second user device 410, the public ledger 406, and/or the transaction system 412, and/or a title registry database TR.DBMS of the title registry server 414 may comprise one or more prior art database management systems including, but not limited to, an ORACLE DATABASE™ database management system marketed by Oracle Corporation, of Redwood City, Calif.; a Database 2™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; and the POSTGRESQL™ open source object-relational database management system.

It is understood that the first private ledger 402, the second private ledger 404, the public ledger 406, the first user device 408, the second user device 410, one or more nodes N.1-N.N of the public ledger 406, and/or the transaction system 412, and/or the title registry server 414 may be a bundled computer hardware and software product such as (a.) a network-communications enabled THINKPAD WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS SERVER™ or WINDOWS 8™ operating system marketed by Microsoft Corporation of Redmond, Wash.; (d.) a MACBOOK PRO™ personal computer as marketed by Apple, Inc. of Cupertino, Calif.; or (e.) other suitable computational system or electronic communications device known in the art capable of providing or enabling a web service known in the art.

It is further understood that the first user device 408 and/or the second user device 410 may be or comprise a bundled portable software and computer hardware product such as an IPHONE 6™ cellular smartphone as marketed by Apple, Inc. of Cupertino, Calif. or other suitable portable electronic communications device known in the art.

It is understood that the operating system by which the first private ledger 402, the second private ledger 404, the public ledger 406, the first user device 408, the second user device 410, one or more nodes N.1-N.N of the public ledger 406, and/or the transaction system 412, and/or a title registry server 414 operate may be selected from freely available, open source and/or commercially available operating system software, to include but not limited to a LINUX ™ or UNIX™ or derivative operating system, such as the DEBIAN™ operating system software as provided by Software in the Public Interest, Inc. of Indianapolis, Ind.; WINDOWS VISTA™ WINDOWS 7™, or WINDOWS 8™ operating system as marketed by Microsoft Corporation of Redmond, Wash.; or the MAC OS X™ operating system or IPHONE 6 OS™ as marketed by Apple, Inc. of Cupertino, Calif..

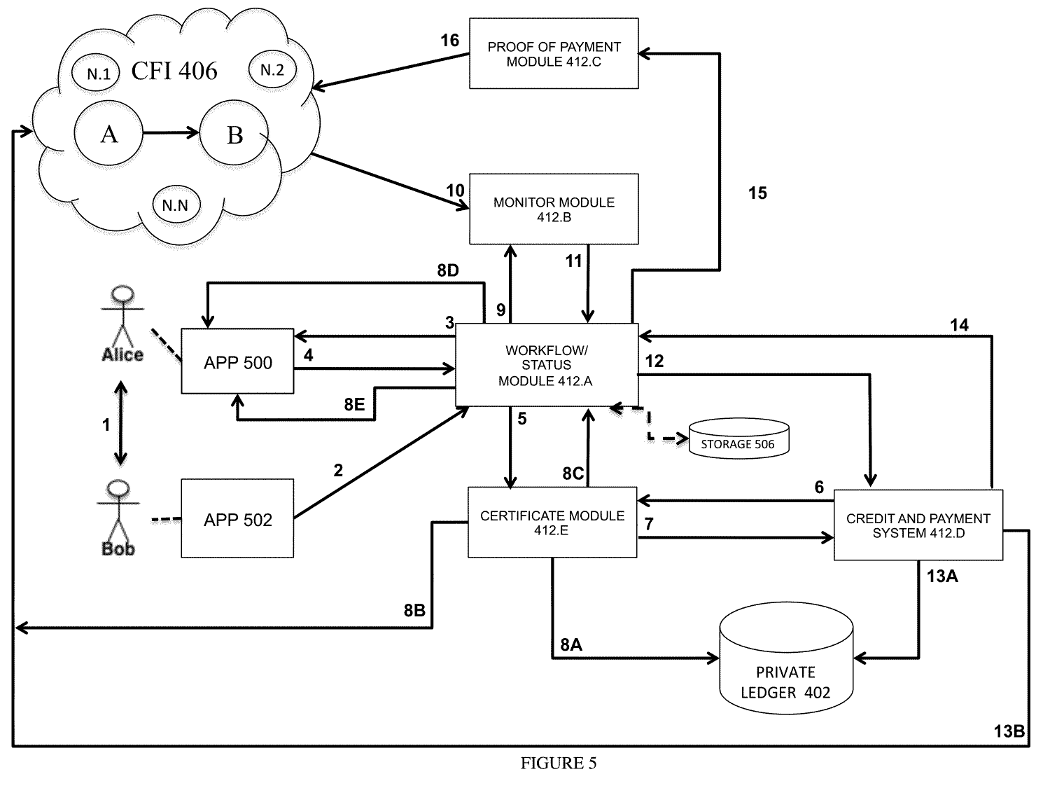

Referring now generally to the Figures, and particularly to FIG. 5, FIG. 5 is a process chart describing a preferred implementation of the invented method. The process chart describes a process by which one or more (in this instance, two) individuals may exchange a cryptocurrency for fiat currency, which process may be facilitated by a private ledger 402, in this instance, a bank. In the first step, a first user Alice of the first user device 408 applies a first applications software 500 (hereinafter “first user app” 500) and a second user Bob of the second user device 410 applies a second applications software 502 (hereinafter “second user app” 502) to mutually agree upon and enable execution of a transfer of assets for funds.

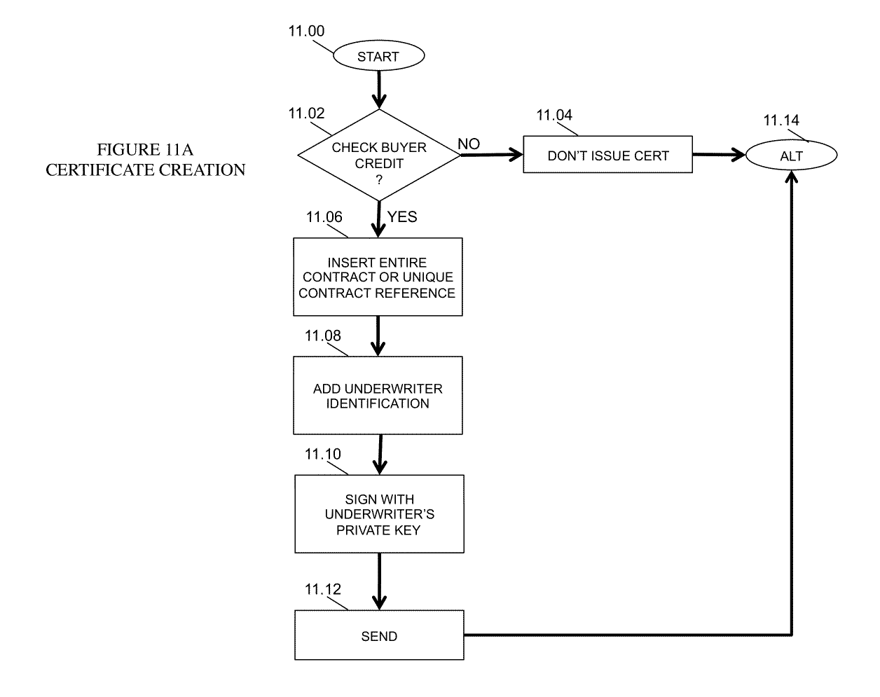

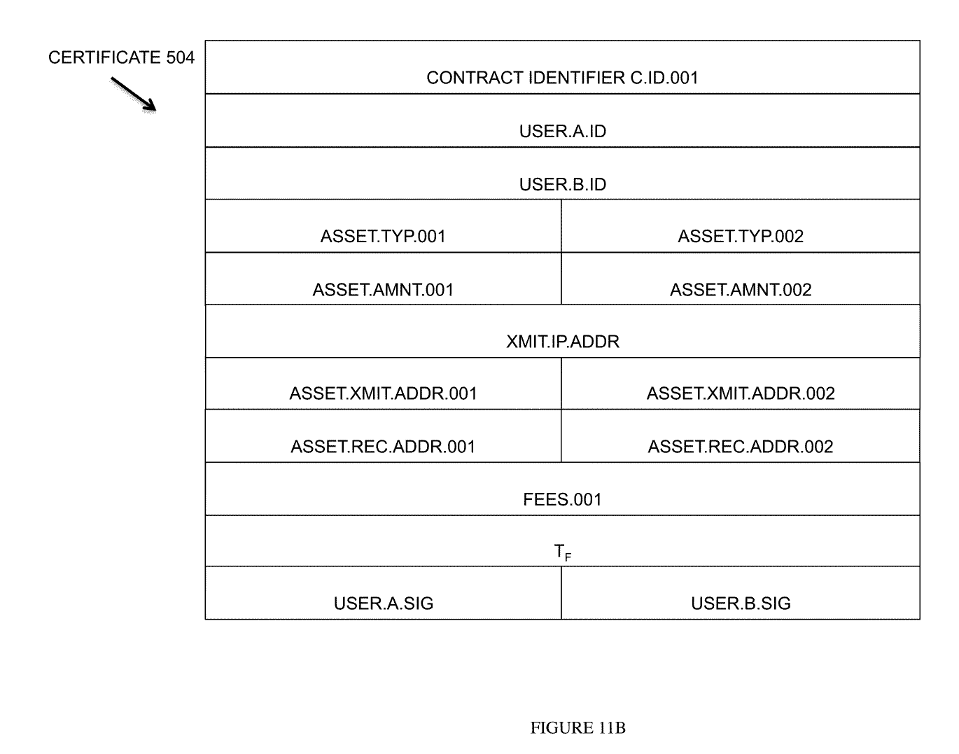

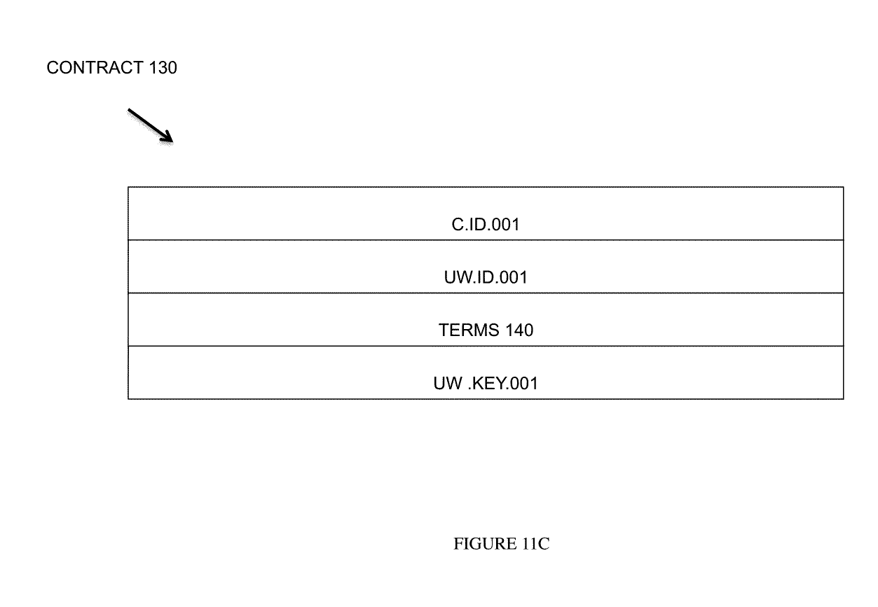

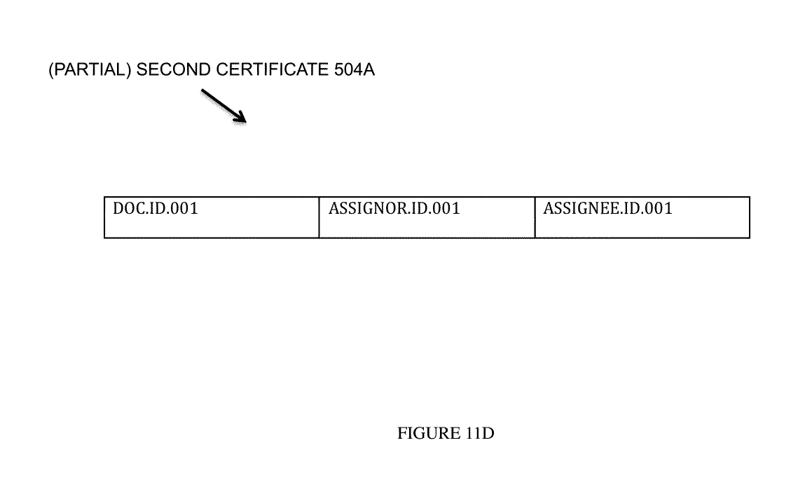

In step 2, the second user device 410 transmits a signed digital contract 130 to the workflow/status module 412.A by means of an electronic communications device, as outlined in the description accompanying FIG. 4. The signature of the second user device 410 is preferably enacted by means of a system of public and private cytological keys; the second user device 410 may “sign” the contract through use of a mathematical “hash” of the second user device 410's private key. The transmission of the digital contract by the second user device 410 to the workflow/status module 412.A initiates an automatic process within the workflow/status module 412.A wherein the proposed digital contract 130, containing the signature of the second user device 410 is transmitted to the electronic device of first user device 408, which process is contained within step 3. In step 4, the first user device 408 signs the digital contract 130, using the same means as the second user device 410, and returns the digital contract to the workflow/status module 412.A. The workflow/status module 412.A subsequently transmits the digital contract 130 to a certificate module 412.E, and requests that an exemplary first digital certificate 504 be transmitted back to the workflow/status module 412.A. The specifications of the exemplary first digital certificate 504 may found in FIG. 11B and accompanying text. It is understood that the workflow/status module 412.A is bidirectionally communicatively coupled within DBMS that maintains electronic documents such as digital certificates 504 & 504.A-504.N, contracts 130 & 130.A-130.N and user accounts in a storage module 506.

The workflow/status module 412.A subsequently, in step 6, requests payment approval from the credit and payment system 412.D. The credit and payment systems 412.D accepts or rejects the payment approval in step 7, and returns a certificate (in the case of approval), or an error message (in the case of rejection) in step 8. In this step, the credit and payment system 412.D places a hold on the designated monetary transaction amount in the account of the second user device 410. In an optional step 8a, the workflow/status module 412.A writes the digital certificate 504 to the first private ledger 402. In a further optional step 8b, the digital certificate 504 is transferred to a CDI public ledger 406. In step 8c the workflow/status module 412.A notifies the monitor module 412.B to monitor the public ledger 406 for the transactions specified in the digital certificate 504 and/or the digital contract 130. When the monitor module 412.B returns a transaction specified in the digital certificate 504 and/or the digital contract 130, the monitor module 412.B transmits the results to the workflow/status module 412.A, and the workflow/status module 412.A notifies the first user device 408 in step 8d, and the second user device 410 in step 8e. Upon notification, the first user device 408 transfers assets such as cryptocurrency to the second user device 410 in a public ledger 406 transaction in step 9. The monitor module 412.B detects the transfer of assets from the first user DEVICE 408 to the second user device 410 in step 10a, and the monitor module 412.B notifies the workflow/status module 412.A of the completion of the public ledger 406 transaction in step 10b. In step 11 the workflow/status module WRFK.001 notifies the credit and payment system 412.D that the public ledger 406 asset transaction has been completed, and that the first private ledger 402 transaction may now occur. In step 12, the credit and payment system 412.D allows the funds put on hold from the account of the second user device 410 to transfer to either the public ledger 406 account or the first private ledger 402 of the first user device 408.

In step 14 the credit and payment system 412.D notifies the workflow/status module 412.A module that the payment has been completed. In step 15 the workflow/status module 412.A notifies the proof of payment module 412.0 to record the transaction. In step 16, the proof of payment module 412.0 records the completion of the transaction onto the public ledger 406.

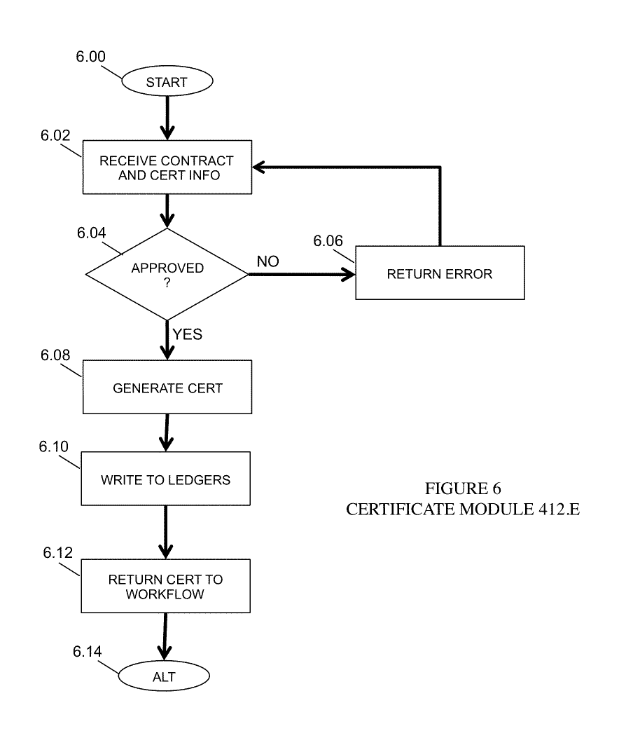

Referring now generally to the Figures, and particularly to FIG. 6, FIG. 6 is a flowchart of an aspect of the invented method whereby a certificate module 412.E receives certificate information and generates a first digital certificate 504. In step 6.02 the certificate module 412.E receives information relevant to the exemplary first contract 130, and the first certificate 504 from the workflow/status module 412.A. The information received may include, but is not limited to, information about the first user device 408 and the second user device 410 and USER.B entering into the proposed first contract 130, information concerning the quantity of assets entering into the transaction, and/or information concerning the beginning and destination addresses of the assets engaged in the transaction. In step 6.04 the certificate module 412.E determines whether, based upon the received information, a certificate 504 will be approved. When the determination in step 6.04 is negative, the certificate module 412.E proceeds to step 6.06, wherein the certificate module 412.E returns an error message to the workflow module 412.A. The certificate module 412.E subsequently proceeds to step 6.02, wherein new information related to the contract 130 and/or the certificate 504 is received. In the alternative, when the determination in step 6.04 is positive, the certificate module 412.E advances to step 6.08, wherein the certificate module 412.E generates the first certificate 504. Subsequent to generation of the first certificate 504, the certificate module 412.E advances to step 6.10, wherein the certificate module 412.E writes the first certificate 504 to the public ledger 406, and to the first private ledger 402. In step 6.12 the certificate module 412.E returns the certificate 504 to the workflow/status module 412.A. In step 6.14 the certificate module 412.E executes alternate processes.

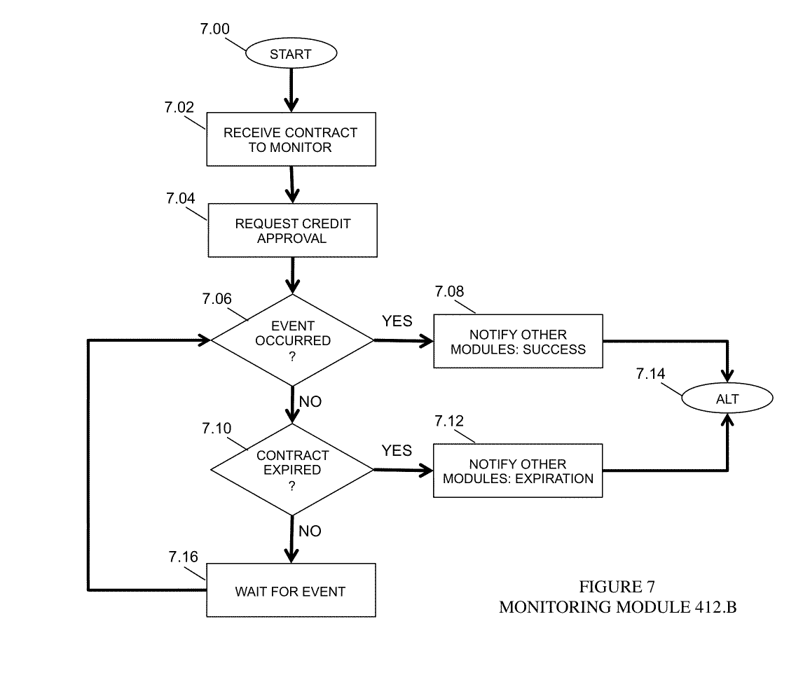

Referring now generally to the Figures, and particularly to FIG. 7, FIG. 7 is a flowchart of a further aspect of the invented method whereby the monitoring module 412.B tracks the status of a contract 130. In step 7.02 the monitoring module 412.B receives a contract 130 and specific tracking instructions from the workflow/status module 412.A. The purpose of the monitoring module is to survey the public ledger 406 for the purpose of determining whether a word, key or other type of digital identifier becomes present which may match an event meeting the specifications laid out in the received contract 130 has occurred. Events for which the monitoring module 412.B may monitor the public ledger 406 include, but are not limited to, specific asset transfer types, specific asset transfer amounts, and/or weather events. In step 7.04 the monitoring module 412.B requests proof of credit approval from the workflow/status module 412.A. In step 7.06 the monitoring module 412.B determines whether a word, key, or other identifier is present matching the event for which the monitoring module 412.B was surveying the public ledger 406 is present. When the determination in step 7.06 is positive, the monitoring module 412.B advances to step 7.08, wherein the monitoring module 412.B transmits a notification to the other modules 412.A, 412.C, $12.D & 412.E comprising the transaction system 412 of the occurrence of the event. Subsequent to step 7.08, the monitoring module 412.B proceeds to step 7.14, wherein alternate processes are executed.

Alternatively, when the determination in step 7.06 is negative, the monitoring module 412.B determines in step 7.10 whether the designated contract 130 has expired. When the determination in step 7.10 is positive, the monitoring module 412.B transmits a notification to the other modules comprising the transaction system 412 of the expiration of the contract 130. The monitoring module 412.B subsequently executes alternate processes in step 7.14. In the alternative, when the monitoring module 412.B determines in step 7.10 that the designated contract 130 has not expired, the monitoring module 412.B proceeds to step 7.16, wherein the monitoring module 412.B waits for the designated event to occur. The monitoring module 412.B subsequently returns to step 7.06, repeats the loop of steps 7.06 through 7.16 as necessary.

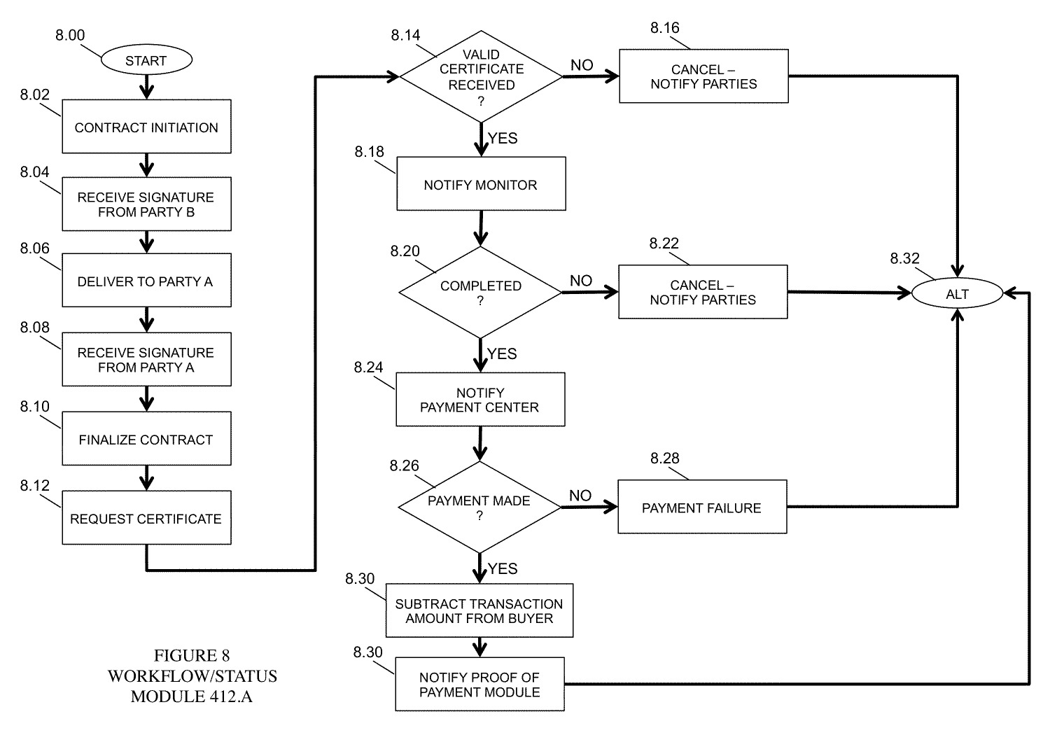

Referring now generally to the Figures and particularly to FIG. 8, FIG. 8 is a flowchart of a yet further aspect of the invented method whereby a workflow/status module 412.A directs and facilitates execution of a contract 130 and a transaction. In step 8.02 the workflow/status module 412.Agenerates an outline for the exemplary first contact 130. In step 8.04 the workflow/status module 412.A receives the first contract 130 with an electronic, cryptographic signature from the electronic device second user device 410. In step 8.06 the workflow/status module 412.A delivers the first contract 130 to the first user device 408. The workflow/status module 412.A in receives in step 8.08 the first contract 130 with an electronic, cryptographic signature from the electronic device of the first user device 408. In step 8.10 the workflow/status module 412.A finalizes the first contract 130. In step 8.12 the workflow/status module 412.A requests a certificate 504 from the certificate module 412.E.

In step 8.14 the workflow/status module 412.A determines whether a valid certificate 504 has been received from the certificate module 412.E. When the determination in step 8.14 is negative, a no valid certificate 504 has been received, the 412.A cancels the process, and notifies the first user device 408 and the second user device 410 of the cancellation. The workflow/status module 412.A subsequently advances to step 8.34, wherein the workflow/status module 412.A executes alternate processes. In the alternative, when the determination in step 8.14 is positive, the workflow/status module 412.A advances to step 8.18 wherein the workflow/status module 412.A notifies the monitor module 412.B of the valid certificate 504. In step 8.20 the workflow/status module 412.A determines whether the monitor module 412.D has returned an instance of a designated event, which instance determines the completion of a certificate 504. When the determination in step 8.20 is negative, the workflow/status module 412.A cancels the process, and notifies the first user device 408 and the second user device 410 of the cancellation. The workflow/status module 412.A subsequently advances to step 8.34, wherein the process is terminated. Alternatively, when the determination in step 8.20 is positive, the workflow/status module 412.A determines in step 8.26 whether assets have been transferred from the second user device 410 to the first user device 408. When the determination in step 8.26 is negative, the workflow/status module 412.A notifies the first user device 408 and the second user device 410 of the payment failure, and advances to step 8.34, wherein the workflow/status module 412.A executes alternate processes. When the determination in step 8.26 is positive, the workflow/status module 412.A subtracts the agreed-upon amount from the account of the first user device 408 in either the first private ledger 402 or in the public ledger 406. In step 8.32 the workflow/status module 412.A notifies the proof of payment module 412.0 of the completed transaction, and advances to step 8.34, wherein the workflow/status module 412.A executes alternate processes.

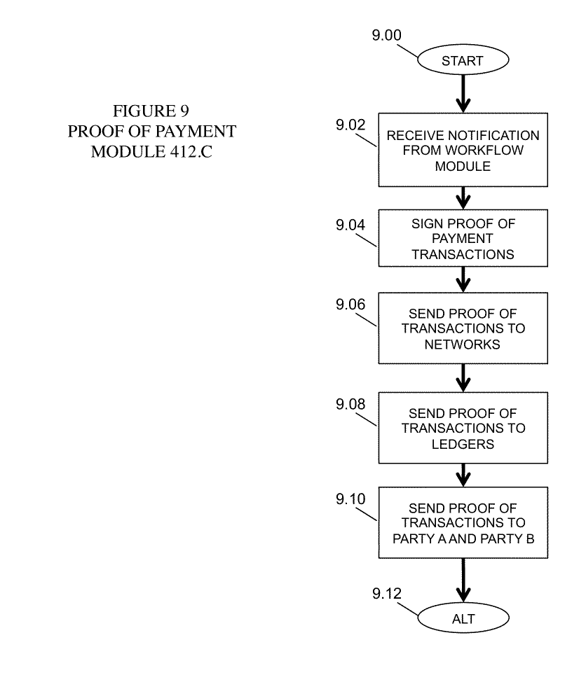

Referring now generally to the Figures and particularly to FIG. 9, FIG. 9 is a flowchart of an aspect of the invented method whereby the proof of payment module 412.0 participates in a transaction. In step 9.02 the proof of payment module 412.0 receives a notification of a successfully executed contract from the workflow/status module 412.A. In step 9.04 the proof of payment module 412.0 affixes an electronic signature to the proof of payment transactions. In step 9.06 the proof of payment module 412.0 transmits the proof of transactions to the other modules on within the transaction system 412. In step 9.08 the proof of payment module 412.0 transmits the proof of transactions to the first private ledger 402 and to the public ledger 406. In step 9.10 the proof of payment module 412.0 transmits the proof of transactions to the first user DEVICE 408 and the second user device 410. In step 9.12 the proof of payment module 412.0 executes alternate processes.

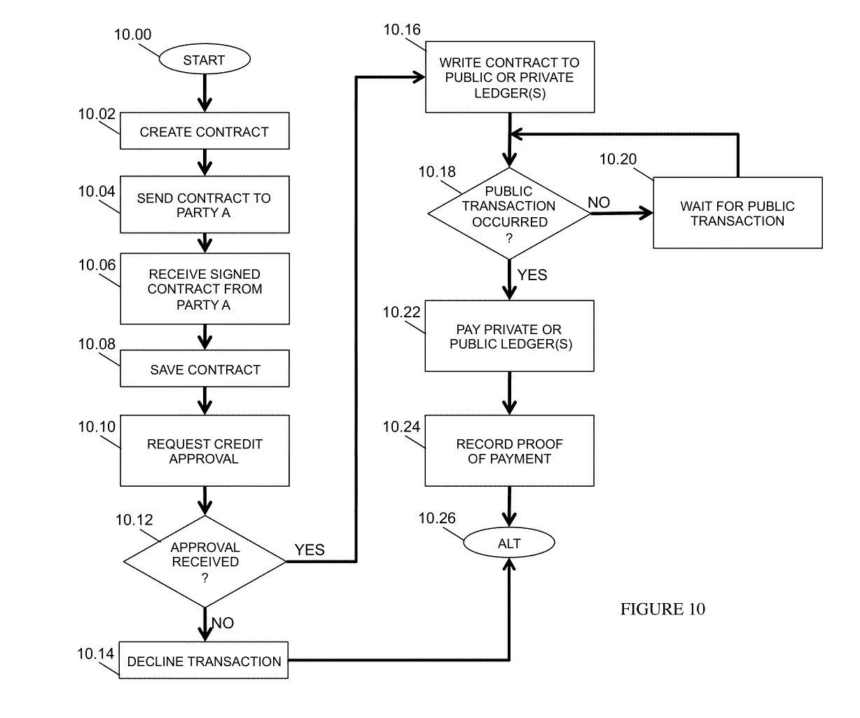

Referring now generally to the Figures, and particularly to FIG. 10, FIG. 10 is a flowchart of a yet additional aspect of the invented method whereby a procedure is performed within a funds transfer, or “bank dash” 1000, within the first private ledger 402. In one preferred embodiment of the invented method the first private ledger 402 is maintained by a financial institution, such as a bank. In step 10.02 a first contract 130 is created. In step 10.04 the first contract 130 is transmitted to the electronic device of the first user device 408. In step 10.06 of the first private ledger 402 may receive the first contract 130 with the signature of the first user device 408 affixed thereto. In step 10.08 the first private ledger 402 saves the contract to local storage. In step 10.10 the first private ledger 402 requests credit approval from the credit and payment system 412.D for the desired transaction. In step 10.12 the first private ledger 402 determines whether approval has been received from the credit and payment system 412.D. When the determination in step 10.12 is negative, the transaction is declined, and t the first private ledger 402 advances to step 10.26, wherein the bank dash 1000 executes alternate processes.

Alternatively, when the determination in step 10.12 is positive, the first private ledger 402 writes the first contract 130 to itself, the second private ledger 404 and/or to the public ledger 406 in step 10.16. In step 10.18 the first private ledger 402 determines whether a public transaction, or an event related to a public transaction has appeared in the public ledger 406. When the determination in step 10.18 is negative, the first private ledger 402 proceeds to step 10.20 and waits for a public transaction to appear. In the alternative, when the determination in step 10.18 is positive, the first private ledger 402 advances to step 10.22, wherein the first private ledger 402 pays the accounts held in either the public ledger 406, the second private ledger 404 or the first private ledger 402. In step 10.24 the first private ledger 402 records the proof of payment from the proof of payment module 412.C. In step 10.26 the first private ledger 402 executes alternate processes.

Referring now generally to the Figures and particularly to FIG. 11A, FIG. 11A is a flowchart of an aspect of the invented method whereby a first certificate 504 is generated. In step 11.02 the certificate module 412.E determines whether to check the credit of the user USER.A or USER.B attempting to participate in a transaction. When the determination in step 11.02 is negative, the certificate module 412.E does not issue a certificate 504. Upon execution of step 11.04, the certificate module 412.E executes alternate processes in step 11.14. In the alternative, when the determination in step 11.02 is positive, the certificate module 412.E inserts either the entire received contract 130, or a unique identifier C.ID.001 to the received contract 130 in step 11.06. In step 11.08 the certificate module 412.E adds an underwriter identification UUW.ID.001; the underwriter may be, for example, a bank. In step 11.10 the certificate module 412.E signs the certificate 504 with the private cryptologic key UW.KEY.001 of the underwriter. In step 11.12 the certificate module 412.E transmits the certificate 504 to the workflow/status module 412.A. The certificate module 412.E subsequently returns to step 11.14, wherein the certificate module 412.E executes alternate processes.

Referring now generally to the Figures, and particularly to FIG. 11B, FIG. 11B is a block diagram of the exemplary first certificate 504. The exemplary first certificate 504 comprises: (a.) a reference to the exemplary first contract CONT.ID.001; (b.) a first user identification USER.A.ID; (c.) a second user identification USER.B.ID; (d.) a first asset type ASSET.TYPE.001; (e.) a first asset amount ASSET.AMNT.001; (f.) a second asset type ASSET.TYPE.002; (g.) a second asset amount ASSET.AMNT.002; (h.) an I.P. address from which the assets may be transmitted XMIT.IP.ADDR; (i.) an address from which the first asset may be transmitted ASSET.XMIT.ADDR.001; (j.) an address from with the first asset may be received ASSET.REC.ADDR.001; (k.) an address from which the second asset may be transmitted ASSET.XMIT.ADDR.002; (l.) an address from which the second asset may be received ASSET.REC.ADDR.002; (m.) any requisite transaction fees FEES.001; (n.) a final time at which the first certificate 504 may expire at an expiration time T_{F}; (o.) the signature of the first user device 408.SIG; and (p.) the signature of the second user device 410.SIG.

Referring now generally to the Figures, and particularly to FIG. 11C, FIG. 11C is a block diagram of an exemplary first contract 130. The exemplary first contract 130 comprises: (a.) a unique contract identifier C.ID.001; (b.) a unique identifier for the underwriter of the first contract UW.ID.001; (c.) the terms of the contract terms 140; and (d.) an encrypted key signature of the underwriter of the first contract UW.KEY.001.

FIG. 11D is a partial block diagram of an exemplary second certificate 504A that is applicable to a title transaction of an exemplary first title record T.01 of a plurality of title records T.01-T.N stored within a title registry database management system TR.DBNS. The referenced first title record T.01 may be an electronic document that registers an assignment of a CDI 150 -150N, a financial security, title to a physical object and/or an ownership right over a measure of a commodity, a crypto-digital instrument, a fiat currency instrument, a digital asset, or real property. The second certificate 504A includes an exemplary title document identifier DOC.ID.001, an exemplary first assignor identifier ASSIGNOR.ID.001 and an exemplary first assignee identifier ASSIGNEE.ID.001. When received by the title registry server 414, the second certificate 504.A directs and authorizes the title registry server 414 to record in the first title record T.01 an assignment of ownership from the indicated first assignor identifier ASSIGNOR.ID.001 to the first assignee identifier ASSIGNEE.ID.001 of the first title record T.01 uniquely associated with the title document identifier DOC.ID.001.

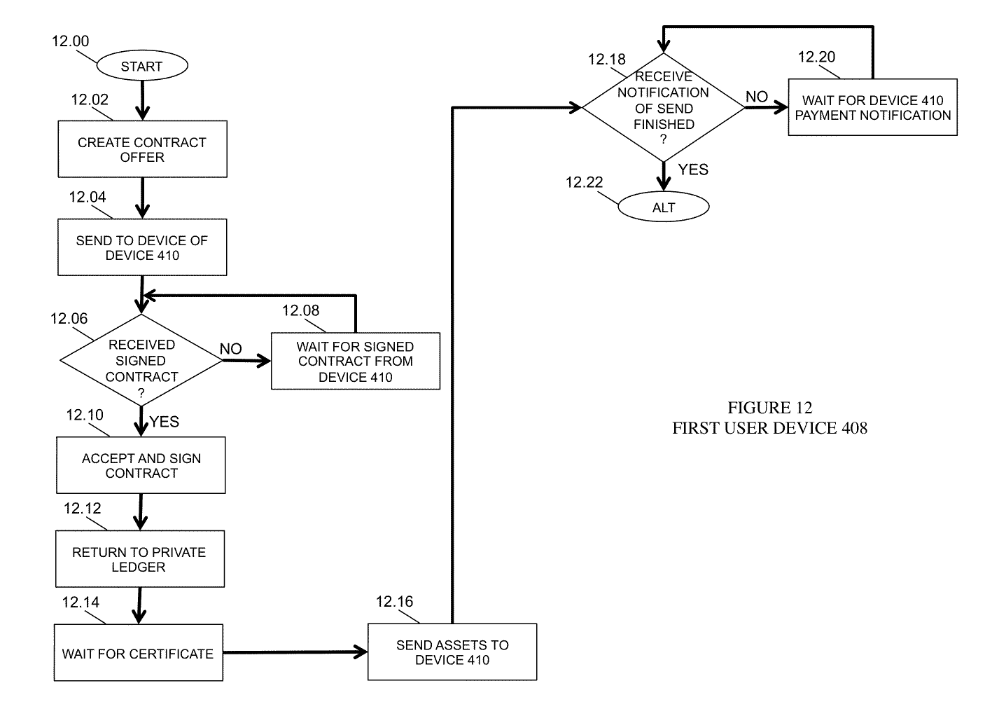

Referring now generally to the Figures, and particularly to FIG. 12, FIG. 12 is a flowchart of an aspect of the invented method describing the role of the device of the first user device 408 in a transaction. In step 12.02 the first user's device 408 creates a contract 130 for transmission to, and approval from, the second user device 410. In step 12.04 the first user's device 408 transmits the contract 130 to the second user device 410. In step 12.06 the first user's device 408 determines whether the contract 130 with the second user device 410's affixed electronic signature has been received from the second user device 410. When the determination in step 12.06 is negative, the first user's device 408 proceeds to step 12.08, wherein the first user's device 408 waits for the signed contract 130 from the second user device 410 for a designated period of time. The first user's device 408 subsequently returns to step 12.06 and repeats the loop of steps 12.06 through 12.08 as necessary. In the alternative, when the determination in step 12.06 is positive, the first user's device 408 accepts the returned contract 130 and affixes the first user device's 408 electronic signature thereto in step 12.10. In step 12.12 the first user's device 408 subsequently returns the signed contract 130 to the first private ledger 402. In step 12.14 the first user's device 408 waits for a certificate 504 to be returned from the certificate module 412.E via the workflow/status module 412.A. When the first user's device 408 receives the certificate 504, the first user's device 408 sends the agreed-upon assets to the second user device 410 in step 12.16.

In step 12.18 the first user's device 408 determines whether a notification of completed transfer has been received. When the determination in step 12.18 is negative, the first user's device 408 waits for the notification of a completed transfer in step 12.20, and subsequently returns to step 12.18, and repeats the loop of steps 12.18 through 12.20 as necessary. Alternatively, when the determination in step 12.20 is positive, the first user's device 408 executes alternate processes in step 12.22.

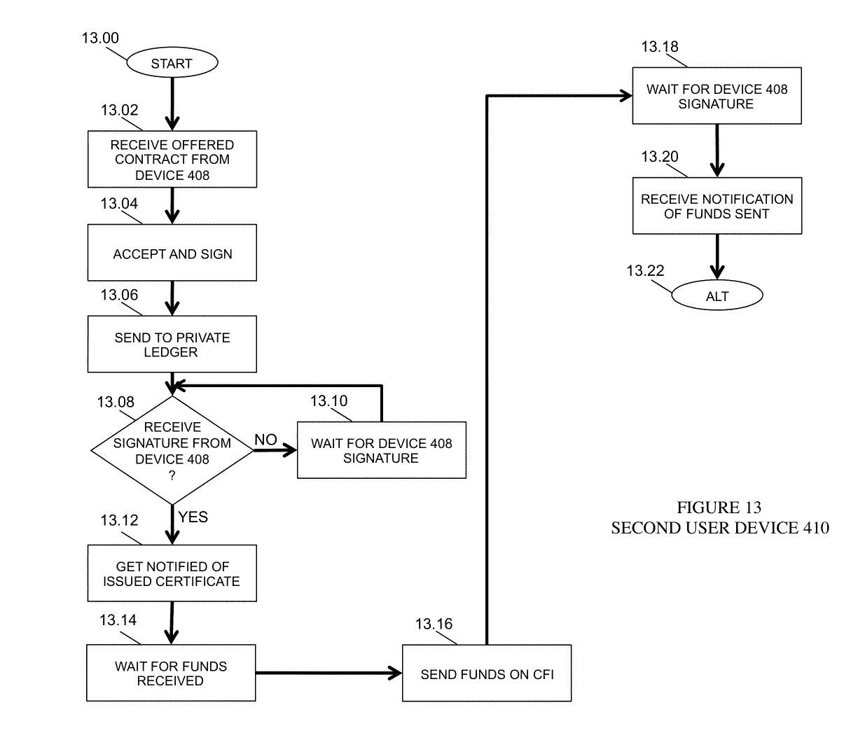

Referring now generally to the Figures and particularly to FIG. 13, FIG. 13 is a flowchart of a further aspect of the invented method whereby second user device 410 takes part in a transaction. In step 13.02 the second user device 410 receives an offered contract 130 from the first user DEVICE 408. In step 13.04 the second user device 410 accepts the offered contract 130 and affixes the second user device 410's electronic signature thereto. In step 13.06 the second user device 410 transmits the contract 130 to the first private ledger 402. In step 13.08 the second user device 410 determines whether the contract 130 with a signature has been received from the first user DEVICE 408. When the determination in step 13.08 is negative, the second user device 410 proceeds to step 13.10, wherein the second user device 410 waits for the signed contract from the first user DEVICE 408. The second user device 410 subsequently returns to step 13.08 and re-executes the loop of steps 13.08 through 13.10 as necessary. Alternatively, when the determination in step 13.08 is positive, the second user device 410 receives notification from the workflow/status module 412.A of an issued certificate 504 in step 13.12. In step 13.14 the second user device 410 waits for assets to be transmitted from the first user's device 408. In step 13.16 the second user device 410 transmits funds to the first user DEVICE 408 via the public ledger 406. In step 13.18 the second user device 410 receives notification of the transmitted funds. In step 13.20 the second user device 410 executes alternate processes.

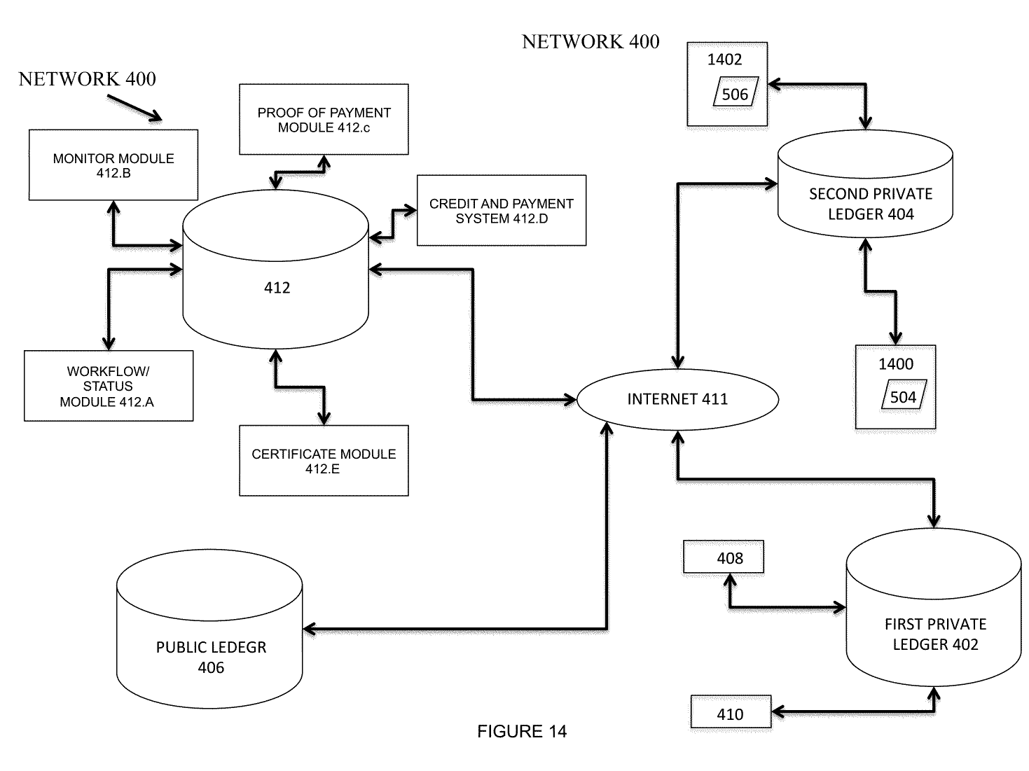

Referring now to the Figures and particularly to FIG. 14, FIG. 14 is an additional network diagram of the network 400 further comprising a third user device 1400 and a fourth user device 1402. may be a bundled computer hardware and software product such as (a.) a network-communications enabled THINKPAD WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS SERVER™ or WINDOWS 8™ operating system marketed by Microsoft Corporation of Redmond, Wash.; (d.) a MACBOOK PRO™ personal computer as marketed by Apple, Inc. of Cupertino, Calif.; (e.) an IPHONE 6™ cellular smartphone as marketed by Apple, Inc. of Cupertino, Calif.; or (f.) other suitable computational system or electronic communications device known in the art capable of providing or enabling a web service known in the art.

The first private ledger 402 serves as an intermediary between an exemplary first user device 408, the second user 410, and the network 400. Similarly the second private ledger 404 serves as an intermediary between the third user device 1400, the fourth user device, 1402 and the network 400. A third human user Carol of the third user device 1400 applies a third applications software 504 (hereinafter “third user app” 504) and a fourth human user Dave of the fourth user device 410 applies a fourth applications software 506 (hereinafter “fourth user app” 502) to mutually agree upon and enable execution of a transfer of assets for funds.

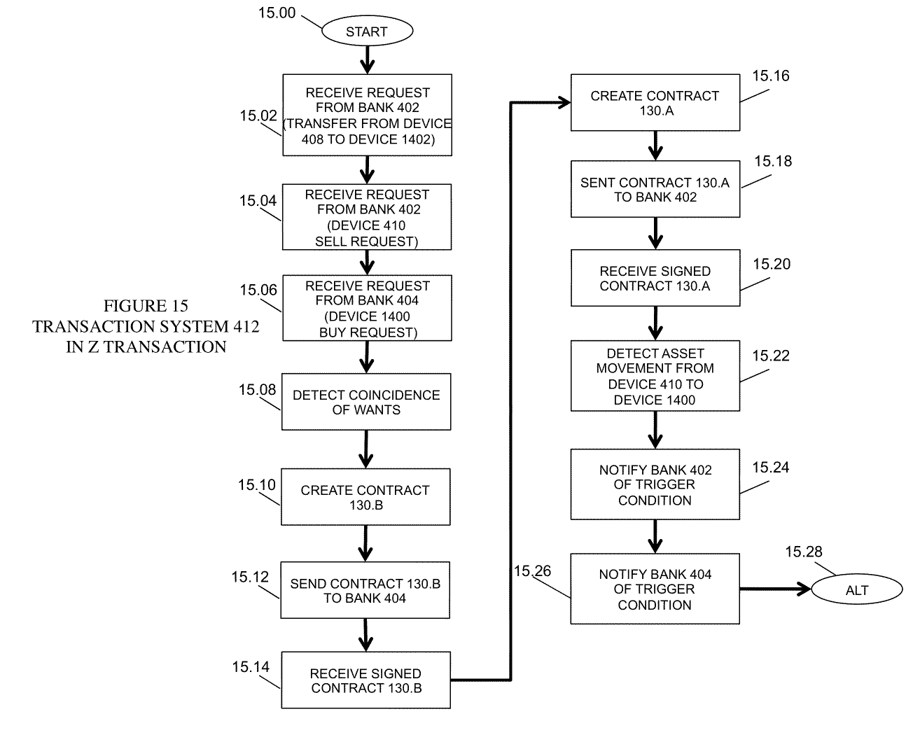

Referring now generally to the Figures, and particularly to FIG. 15, FIG. 15 is a flowchart of an aspect of the invented method whereby the first private ledger 402, the second transaction server 410 and the transaction server 412 takes part in a “Z” transaction, which transaction includes the above-listed first private ledger 402, second private ledger 404, the public ledger 406, the first user device 408, the second user device 410, the third user device 1400 and the fourth user device 1402. The Z transaction further includes a second exemplary contract 130.A and a third exemplary contract 130.B, associated with the first private ledger 402 and the second private ledger 404, respectively.

In step 15.02 the Transaction server 412 receives a request from the first private ledger 402 to execute a transfer from the first user device 408, associated with the first private ledger 402, to the fourth user device 1402, associated with the second private ledger 404. In step 15.04 the Transaction server 412 receives a second request from the first private ledger 402, indicating that the second user device 410 desires a sale of cryptocurrency. In step 15.06 the Transaction server 412 receives a request from the second private ledger 404, indicating that the third user device 1400 wishes to buy cryptocurrency. In step 15.08 the Transaction server 412 detects the coincidence of wants between the first user device 408, the second user device 410, and the third user device 1400. In step 15.10 the Transaction server 412 creates the third contract 130.B, and transmits the third contract 130.B to the second private ledger 404 in step 15.12. In step 15.14 the Transaction server 412 receives the third contract 130.B from the second private ledger 404, with the affixed electronic signatures of the designated users. In step 15.16 the Transaction server 412 creates the second contract 130.A, and transmits the second contract 130.A to the first private ledger 402. The Transaction server 412 subsequently receives the second contract 130.A from the first private ledger 402, with affixed electronic signatures from the designated users in step 15.20. The Transaction server 412 may then detect asset movement from the second user device 410 to the third user device 1400, which transfer may act as a trigger condition for additional transfers of funds and assets in step 15.22. In step 15.24 the Transaction server 412 notifies the first private ledger 402 of the transfer from the second user device 410 to the third user device 1400. In step 15.26 the Transaction server 412 notifies the second private ledger 404 of the transfer from the second user device 410 to the third user device 1400. The Transaction server 412 then proceeds to step 15.28, wherein the Transaction server 412 executes alternate processes.

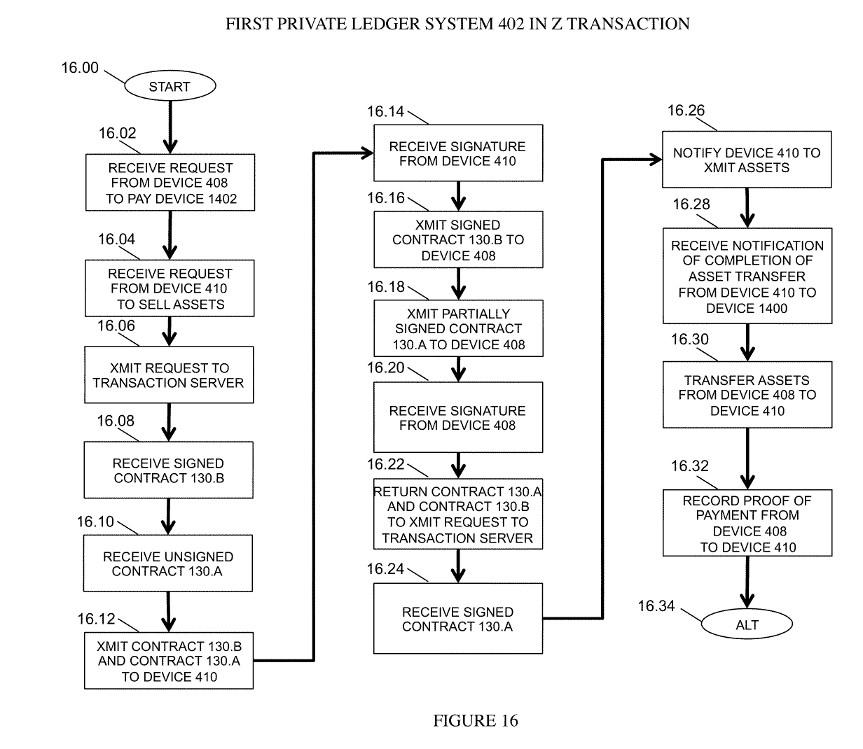

Referring now generally to the Figures, and particularly to FIG. 16, FIG. 16 is a flowchart depicting an aspect of the invented method whereby the first private ledger 402 takes part in a “Z” transaction. In step 16.02 the first private ledger 402 receives a request from the first user device 408 to transfer funds to the fourth user device 1402, wherein the fourth user device 1402 is associated with the second private ledger 404. In step 16.04 the first private ledger 402 receives a request from the second user device 410 to sell designated assets. In step 16.06 the first private ledger 402 transmits the requests of the first user device 408 and the second user device 410 to the Transaction server 412. In step 16.08 the first private ledger 402 receives the third contract 130.B from the Transaction server 412, with designated electronic signatures attached. In step 16.10 the first private ledger 402 receives the unsigned second contract 130.A from the Transaction server 412. In step 16.12 the first private ledger 402 transmits the second contract 130.A and the third contract 130.B to the second user device 410. In step 16.14 the first private ledger 402 receives the second contract 130.A and the third contract 130.B from the second user device 410 with the second user device 410's affixed electronic signature. In step 16.18 the first private ledger 402 transmits the third contract 130.B with digital signatures affixed to the first user device 408. In step 16.20 the first private ledger 402 transmits the partially signed second contract 130.A to the first user device 408. In step 16.20 the first private ledger 402 receives the second contract 130.A from first user device 408 with digital signature affixed. In step 16.22 the first private ledger 402 transmits the second contract 130.A and the third contract 130.B to the transaction server 412. In step 16.24 the first private ledger 402 receives the fully signed second contract 130.A from the transaction server 412. In step 16.26 the first private ledger 402 notifies the second user device 410 to transmit assets to the third user device 1400. In step 16.28 the first private ledger 402 receives a notification of the completion of the asset transfer from the second user device 410 to the third user device 1400. In step 16.30 the first private ledger 402 transfers assets from the first user device 408 to the second user device 410. In step 16.32 the first private ledger 402 records proof of the payment from the first user device 408 to the second user device 410. The first private ledger 402 subsequently executes alternate processes.

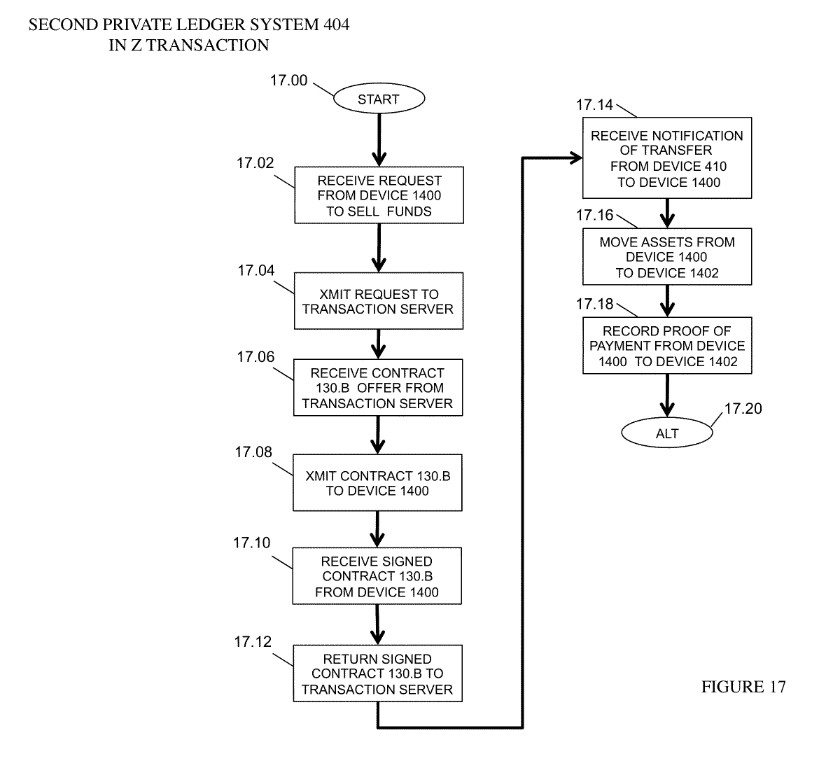

Referring now generally to the Figures, and particularly to FIG. 17, FIG. 17 is a flowchart describing an aspect of the invented method whereby the second private ledger 404 participates in a “Z” transaction. In step 17.02 the second private ledger 404 receives a request from the third user device 1400 to sell a designated amount of funds in exchange for a designated amount of cryptocurrency. In step 17.04 the second private ledger 404 transmits the third user device 1400's request to the transaction server 412. In step 17.06 the second private ledger 404 receives a third contract 130.B offer from the transaction server 412. Upon approval of the third contract 130.B offer, the second private ledger 404 transmits the third contract 130.B to the third user device 1400 in step 17.08. In step 17.10 the second private ledger 404 receives third contract 130.B from the third user device 1400 with an affixed digital signature. In step 17.12 the second private ledger 404 returns the third contract 130.B with the third user device 1400's affixed digital signature to the transaction server 412. In step 17.14 the second private ledger 404 receives notification of the transfer of assets from the second user device 410 to the third user device 1400. In step 17.16 the second private ledger 404 moves assets from the third user device 1400 to the fourth user device 1402. The second private ledger 404 in step 17.18 records proof of payment from the third user device 1400 to the fourth user device 1402. The second private ledger 404 subsequently executes alternate processes.

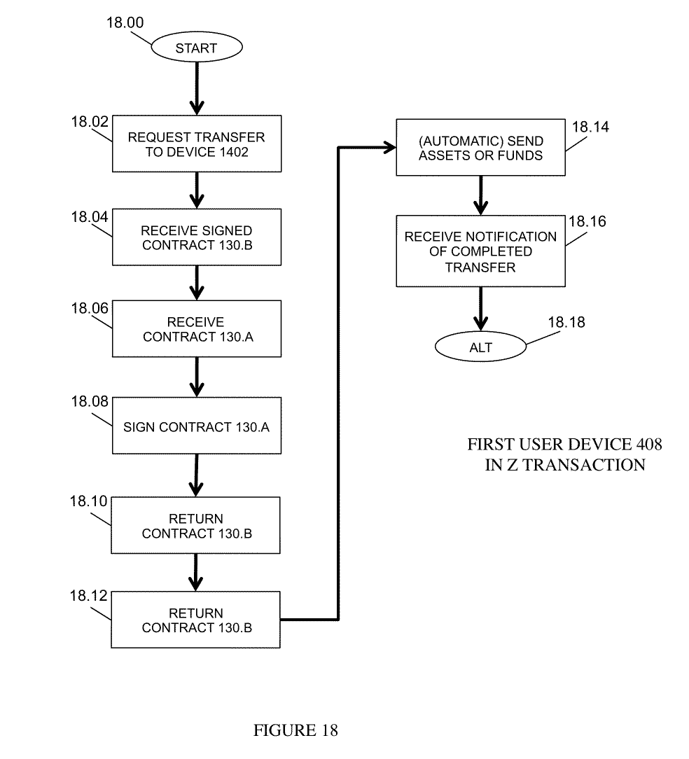

Referring now generally to the Figures, and particularly to FIG. 18, FIG. 18 is a flowchart of an aspect of the invented method whereby the first user device 408's device 500 participates in a “Z” transaction. In step 18.02 the first user's device 408 requests a transfer of funds to the fourth user device 1402. In step 18.04 the first user's device 500 receives the third contract 130.B from the Transaction server 412 with the affixed digital signatures of designated users. In step 18.06 the first user's device 500 receives the second contract 130.B. In step 18.08 the first user's device 500 affixes the digital signature of the first user device 408 to the second contract 130.B. In step 18.10 the first user's device 500 returns the third contract 130.B to the Transaction server 412. In step 18.12 the first user's device 500 returns the second contract 130.A to the Transaction server 412. The assets or funds are subsequently automatically transferred from the account of the first user device 408 in step 18.14. In step 18.16 the first user's device 500 receives notification of the completed transfer of funds. In step 18.18 the first user's device 500 proceeds to alternate processes.

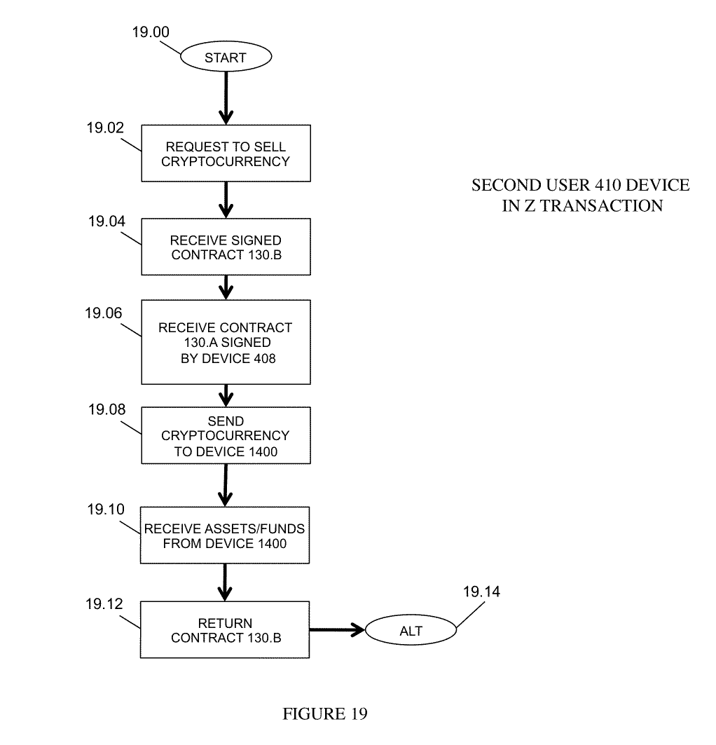

Referring now generally to the Figures and particularly to FIG. 19, FIG. 19 is a flowchart of an aspect of the invented method whereby the second user device 410's device 502 takes part in a “Z” transaction. In step 19.02 the second user's device 502 transmits a request to sell a designated amount of a designated asset; in one preferred embodiment of the invented method, the designated asset is cryptocurrency. In step 19.04 the second user's device 502 receives a signed second contract CONT.001 from the workflow/status module 412.A. In step 19.06 the second user's device 502 receives the second contract 130.A signed by the first user device 408. Upon reception of the signed second contract 130.A, the second user's device 502 transmits the designated amount of cryptocurrency to the third user device 1400 in step 19.08. In step 19.10 the second user's device 502 receives assets and/or funds from the third user device 1400. In step 19.12 the second user's device 502 returns the signed third contract 130.B to the Transaction server 412. In step 19.14 the second user's device 502 proceeds to alternate processes.

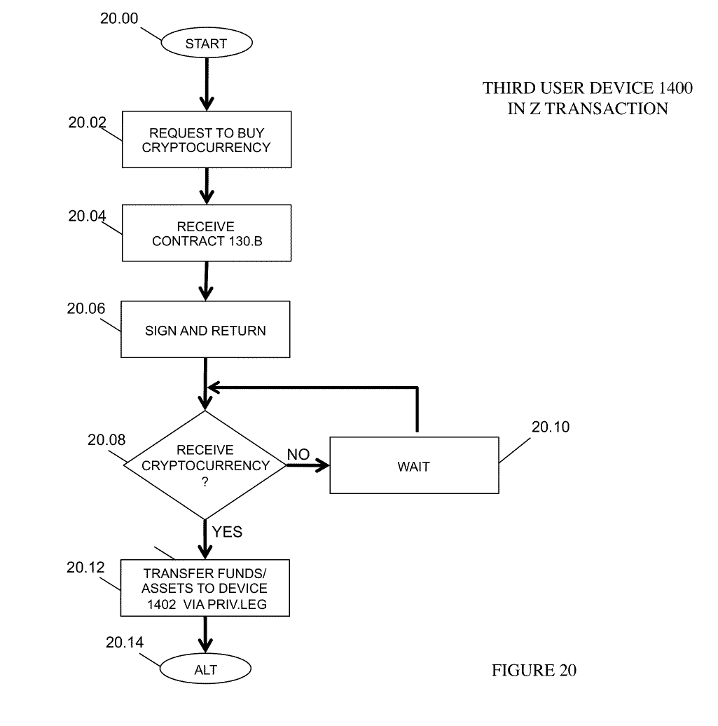

Referring now generally to the Figures and particularly to FIG. 20, FIG. 20 is a flowchart of an aspect of the invented method whereby the third user device 1400's device 504 takes part in a “Z” transaction. In step 20.02 the third user's device 504 transmits a request to purchase a designated amount of cryptocurrency. In step 20.04 the third user's device 504 receives a third contract 130.B from the Transaction server 412. In step 20.06 the third user's device 504 affixes the third user device 1400's electronic signature to the third contract 130.B, and returns the third contract 130.B to the Transaction server 412. In step 20.08 the third user's device 504 determines whether the requested cryptocurrency has been received from the second user device 410. When the determination in step 20.08 is negative, the third user's device 504 proceeds to step 20.10, wherein the third user's device 504 waits for delivery of the requested cryptocurrency from the second user device 410. The third user's device 504 subsequently repeats the loop of steps 20.08 through 20.10 as necessary. Alternatively, when the determination in step 20.08 is positive the third user's device 504 proceeds to step 20.12, wherein the third user's device 504 transfers funds and/or assets to the fourth user device 1402 via the first private ledger 402 and the second private ledger 404. In step 20.14 the third user's device 504 executes alternate processes.

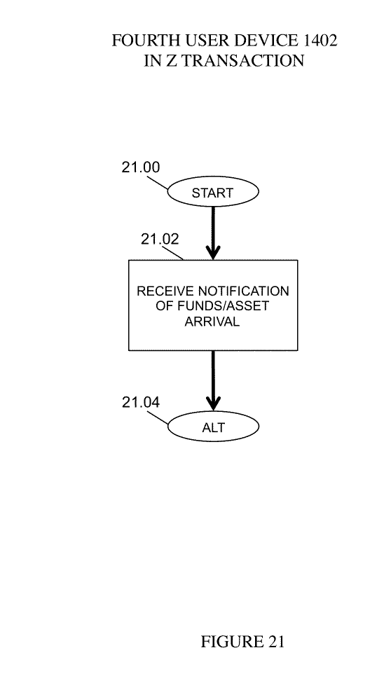

Referring now generally to the Figures and particularly to FIG. 21, FIG. 21 is a flowchart of a yet further aspect of the invented method in which the fourth user device 1402's device 506 takes part in a “Z” transaction. In step 21.02 the fourth user's device 506 receives notification of the arrival of funds and/or assets from the workflow/status module 412.A. In step 21.04 the fourth user's device 506 executes alternate processes.

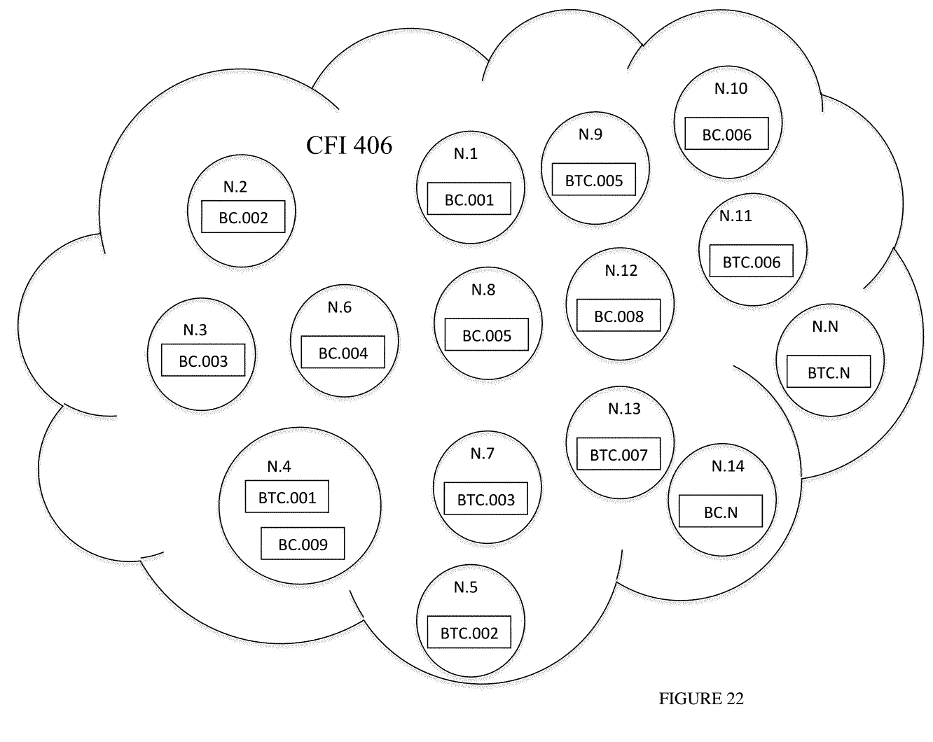

FIG. 22 is a block diagram of the CDI network 406 of FIG. 4 comprising the plurality of nodes N.1-N.N, each node N.1-N.N preferably have an instance of either a BITCOIN BLOCHAIN BTC.001-BTC.N and/or another suitable blockchain BC.001-BC.N known in the art.

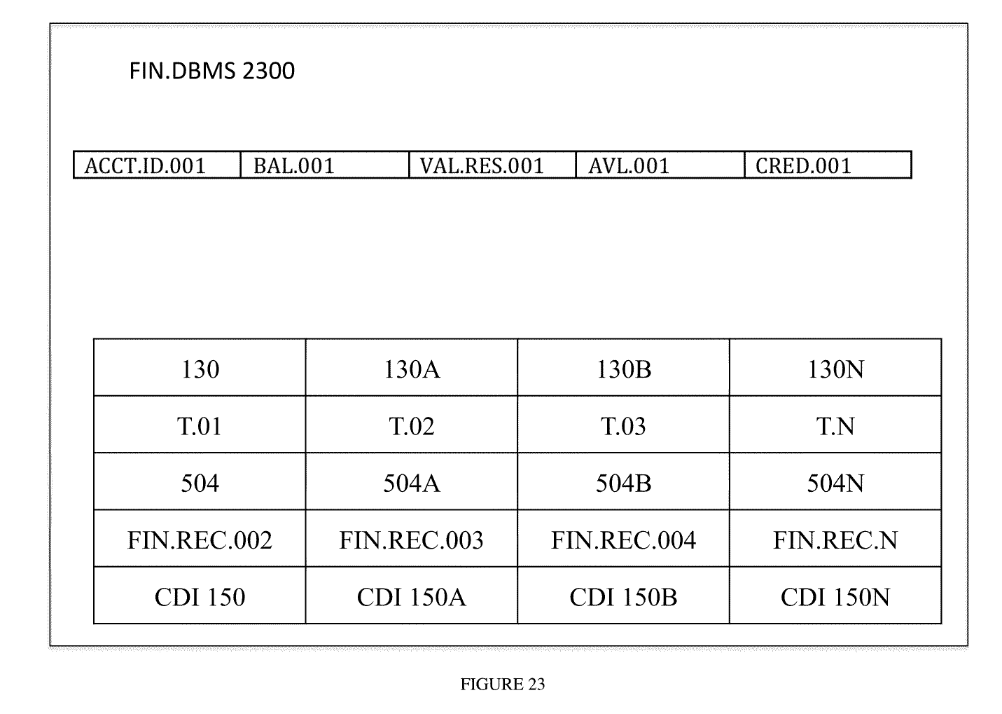

FIG. 23 is a block diagram of a plurality of financial account records FIN.REC.001-FIN.REC.N maintained in a financial database management system FIN.DBMS of the storage module 506 of the transaction server 412, the first private ledger 402 and/or the second private ledger 404. It is noted that a plurality of CDI 150-150N, a plurality title records T.01-T.N, the plurality of contracts 130-130N and the plurality of certificates 504-504N may also be maintained within the financial database management system FIN.DBMS 2300. An exemplary first financial account record FIN.REC.001 that includes an exemplary first account identifier ACCT.ID.001, an exemplary first account currency balance BAL.001, an exemplary first reserved currency value VAL.RES.001, an exemplary first available account currency balance AVL.001, and an exemplary first credit balance CRED.001. The first reserved currency value VAL.RES.001 is a currency value that is associated with comprising valid certificate 504-504N, and made available for transactions based upon the comprising valid certificate 504-504N, until the expiration time Tf of the certificate 504-504N has occurred or passed.

According to the method of FIG. 3, the first reserved currency value VAL.RES.001 is either deducted from the first account currency balance BAL.001 in step 3.12 or provided as transfer from the first credit balance CRED.001 in step 3.10 for summation in the first reserved currency value VAL.RES.001. The first reserved currency value VAL.RES.001 is subsequently either (a.) transferred to the first account currency balance BAL.001 in step 3.16 if no payment is made, or (b.) deducted and transferred to another financial account in step 3.18 as payment on a contract 130-130N.

According to the method of FIG. 10, the first reserved currency value VAL.RES.001 is in step 10.16 either (a.) deducted and transferred from the first account currency balance BAL.001 or (b.) provided as a transfer from the first credit balance CRED.001. According to the method of FIG. 8, the first reserved currency value VAL.RES.001 is subsequently either (a.) transferred to the first account currency balance BAL.001 in step 8.22 if no payment is made, or (b.) deducted and transferred to another financial account in step 8.30 as payment on a contract 130-130N.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

I claim:

1. In a communications network comprising a public ledger network and at least one private ledger system, a method comprising:
a. Associating a first proposed transaction (“the public ledger transaction”) of the public ledger network with a second proposed private ledger transaction (“the private ledger transaction”) of the at least one private ledger system;
b. Attesting that a value required to fulfill for the private ledger transaction is reserved;
c. Receiving notice that the public ledger transaction is fulfilled; and
d. Executing the private ledger transaction.

2. The method of claim 1, wherein the value ceases to be reserved after a set time period.

3. The method of claim 1, wherein the execution of the private ledger transaction is automated and no additional user action is required after receipt of the notice that the public ledger transaction is fulfilled.

4. The method of claim 1, wherein the value is expressed in fiat currency.

5. The method of claim 1, wherein the value is reserved within a financial account.

6. The method of claim 1, wherein the value is provided as a credit to a first party, the first party initiating private ledger transaction.

7. The method of claim 6, wherein the value is denominated in fiat currency.

8. The method of claim 1, wherein the value is recorded within a public ledger prior to an initiation of the public ledger transaction.

9. The method of claim 1, wherein the private ledger transaction comprises an electronic funds transfer of the value.

10. The method of claim 1, wherein the private ledger transaction is an assignment of ownership of a financial instrument or a nonfinancial instrument.

11. The method of claim 1, wherein the private ledger transaction is an assignment of ownership of a CDI.

12. The method of claim 1, wherein the private ledger transaction is an assignment of ownership of an amount of a commodity.

13. The method of claim 1, wherein the public ledger transaction comprises a recordation within the public ledger network related to a crypto-digital instrument.

14. The method of claim 1, wherein the execution of the public ledger transaction is recorded on a public ledger stored by a plurality of nodes of the public ledger network.

15. The method of claim 1, wherein the public ledger network comprises a blockchain.

16. The method of claim 1, wherein the public ledger transaction is recorded on a blockchain.

17. The method of claim 1, wherein the public ledger transaction is recorded on a bitcoin blockchain.

18. The method of claim 1, wherein the public ledger transaction is fulfilled via recordation on a blockchain.

19. The method of claim 18, wherein the public ledger transaction is recorded on a bitcoin blockchain.

20. A system comprising:
a. Means to associate a proposed transaction of a public ledger network (“the public ledger transaction”) with a proposed private ledger transaction (“the private ledger transaction”) of a private ledger;
b. Means to attest that a value required to fulfill for the private ledger is reserved;
c. Means to receive notice that the public ledger transaction is fulfilled; and
d. Means to automatically execute the private ledger transaction upon a determination that the public ledger transaction has been performed.
